(19) United States
(12) Patent Application Publication
(10) Pub. No.: US 2021/0360725 A1
(43) Pub. Date: Nov. 18, 2021

(54) INTERRUPTION HANDLING FOR VEHICLE-TO-EVERYTHING (V2X) COMMUNICATION

(71) Applicant: MediaTek Singapore Pte. Ltd., Singapore (SG)

(72) Inventors: Zhixun Tang, Beijing (CN); Tsang-Wei Yu, Hsin-Chu (CN)

(21) Appl. No.: 17/321,125

(22) Filed: May 14, 2021

Related U.S. Application Data
(63) Continuation of application No. PCT/CN2020/009031, filed on May 14, 2020.

(30) Foreign Application Priority Data
May 6, 2021 (CN) CN202110489596.6

(51) Int. Cl. H04W 76/19; H04W 4/40; H04W 56/00; H04W 76/15; H04L 29/08; H04W 24/04

(52) U.S. Cl. CPC H04W 76/19; H04W 4/40; H04W 56/004; H04W 84/005; H04L 67/12; H04W 24/04; H04W 76/15

(57) ABSTRACT

Apparatus and methods are provided for interruption handling for V2X communication. In one novel aspect, the UE detects an interruption event on the first SL and performs interruption procedure allowing stopping transmission and reception on one or more links of the UE based on the interruption event. In one embodiment, the UE supports both the LTE V2X sidelink and the NR V2X sidelink. The UE performs interruption procedure allowing both the LTE V2X sidelink and the NR V2X sidelink to stop transmission or reception for a preconfigured period. In one embodiment, the interruption event is the UE switching the SL between the LTE V2X sidelink and NR V2X sidelink. Upon detecting the SL switching interruption event, the UE performs the interruption procedure on the Uu link of the UE for a preconfigured period. In one embodiment, the preconfigured period is based on a slot configuration of the first SL.

### CROSS REFERENCE TO RELATED APPLICATIONS

This application is filed under 35 U.S.C. §111(a) and is based on and hereby claims priority under 35 U.S.C. § 120 and § 365(c) from International Application No. PCT/CN/2020/090317, titled “A Method and Apparatus of Interruption for V2X Communication,” with an international filing date of May 14, 2020. This application claims priority under 35 U.S.C. § 119 from Chinese Application Number 202110489596.6, titled “Interruption Handling for Vehicle-to-Everything (V2X) communication,” filed on May 6, 2021. The disclosure of each of the foregoing documents is incorporated herein by reference.

### TECHNICAL FIELD

The disclosed embodiments relate generally to wireless communication, and, more particularly, to interruption handling for V2X communication.

### BACKGROUND

5G radio access technology will be a key component of the modern access network. It will address high traffic growth and increasing demand for high-bandwidth connectivity. In 3GPP New Radio (NR), sidelink continues evolving. With new functionalities supported, the sidelink (SL) offers low latency, high reliability and high throughout for device-to-device communications. Vehicle to everything (V2X) uses sidelink communication. The V2X sidelink communication can be supported by unicast, groupcast, and broadcast communication. The LTE and NR both support V2X sidelink communications. The LTE V2X sidelink focused on broadcast services. In the NR V2X sidelink new types of groupcast and unicast communications are introduced. The V2X SL communication can take different synchronization sources. The UE may switch between the two different types of V2X sidelink, including the NR V2X and the LTE V2X. The UE may switch synchronization sources in different scenarios. Different synchronization sources may not be synchronized with each other. The different scenarios of the change of synchronization sources and/or switch of SL types may cause interruptions.

Improvements and enhancements are required for interruption handling for the V2X communication.

### SUMMARY

Apparatus and methods are provided for interruption handling for V2X communication. In one novel aspect, the UE detects an interruption event on the first SL and performs interruption procedure allowing stopping transmission and reception on one or more links of the UE based on the interruption event. In one embodiment, the UE supports both the Uu link for WAN and NR V2X sidelink. The UE performs interruption procedure to the Uu link upon detecting the RRC reconfiguration for the NR V2X sidelink. In another embodiment, the UE supports both the LTE V2X sidelink and the NR V2X sidelink. The UE performs an interruption to LTE V2X sidelink due to NR V2X sidelink synchronization source change. The UE performs an interruption to NR V2X sidelink due to LTE V2X sidelink synchronization source change. The interruption does not occur before the last LTE SL subframe or NR SL slot switching from and after the first NR SL slot or LTE SL subframe switching to.

In one embodiment, the interruption event is the UE switching the SL either from the LTE V2X sidelink to NR V2X sidelink or from the NR V2X sidelink to the LTE V2X sidelink. Upon detecting the SL switching interruption event, the UE performs the interruption procedure on the Uu link of the UE. The interruption will happen not before the last LTE/NR V2X sidelink subframe/slot switching from and after the first NR/LTE V2X sidelink slot/subframe switching to. In another embodiment, when the UE supports at least NR V2X sidelink and two synchronization sources that UE switches between are not synchronized, for broadcast communication, the sidelink communication will be interrupted with 1 ms due to synchronization sources change. For group-cast and unicast communication, the sidelink communication will be ceased due to synchronization source change. In yet another embodiment, when the UE supports NR V2X sidelink only, the sidelink communication will be interrupted with 1 ms due to synchronization sources change. The interruption will happen immediately after reselection synchronization source procedure. In one embodiment, when the UE supports both Uu link (WAN) and NR V2X sidelink, the sidelink communication will be interrupted with 1 ms due to synchronization sources change between eNB/gNB and gNB/eNB. The interruption will happen after UE Uu link receiving the handover command on the old PDSCH and before UE sending the new PRACH.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network for interruption handling of the V2X communication in accordance with embodiments of the current invention.

FIG. 2 illustrates exemplary diagrams of interruption handling for the WAN when the V2X sidelink changes synchronization source in accordance with embodiments of the current invention.

FIG. 3A illustrates exemplary diagrams of interruptions due to V2X sidelink synchronization source change in accordance with embodiments of the current invention.

FIG. 3B illustrates exemplary diagrams of interruption handling for the V2X sidelink upon detecting the V2X sidelink synchronization source changes in accordance with embodiments of the current invention.

FIG. 4 illustrates exemplary diagrams of interruption detecting and handling due to the switching between the LTE V2X sidelink and the NR V2X sidelink in accordance with embodiments of the current invention.

FIG. 5 illustrates an exemplary flow chart for the interruption handling for the V2X communication in accordance with embodiments of the current invention.

### DETAILED DESCRIPTION

Reference will now be made in detail to some embodiments of the invention, examples of which are illustrated in the accompanying drawings.

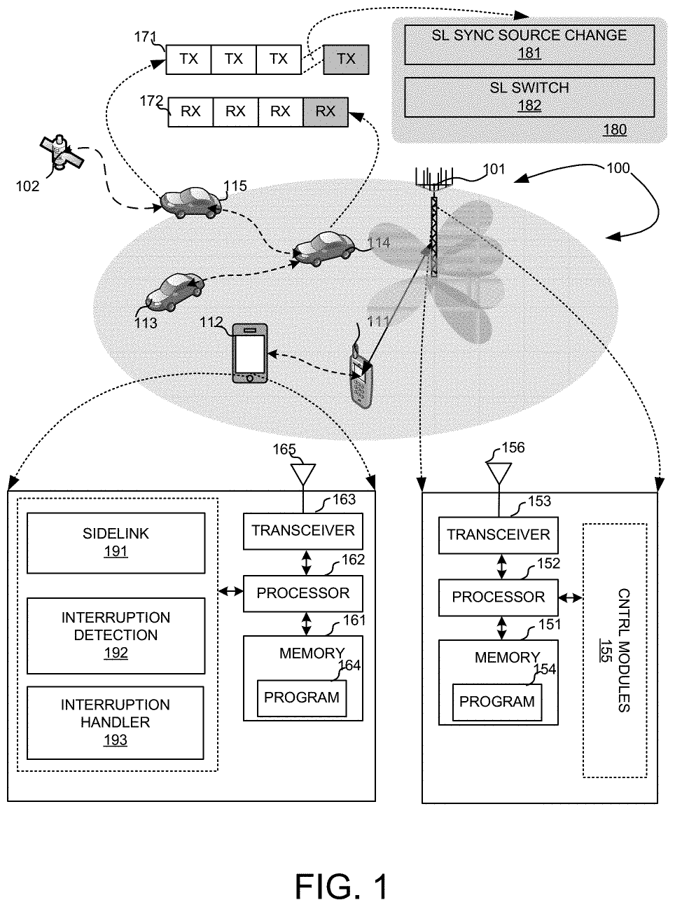

FIG. 1 is a schematic system diagram illustrating an exemplary wireless network for interruption handling of the V2X communication in accordance with embodiments of the current invention. Wireless system 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. The network can be a homogeneous network or heterogeneous network, which can be deployed with the same frequency or different frequency. gNB 101 is an exemplary base station in the NR network. Wireless system 100 also includes the global navigation satellite system (GNSS) 102, which can be a synchronization source for the UE.

Wireless network 100 also includes multiple communication devices or mobile stations, such as user equipments (UEs) 111, 112, 113, 114, and 115. The exemplary mobile devices in wireless network 100 have sidelink capabilities. The mobile devices can establish one or more connections with one or more base stations, such as gNB/eNB 101. UE 111 has an access link, with uplink (UL) and downlink (DL), with gNB 101. UE 112, which is also served by gNB 101, may also establish UL and DL with gNB 101. UE 111 also establishes a sidelink with UE 112. Both UE 111 and UE 112 are in-coverage devices. Mobile devices on vehicles, such as mobile devices 113, 114, and 115, also have sidelink capabilities. Mobile device 113 and mobile device 114 are covered by gNB 101. Mobile device 113, an in-coverage device, establishes sidelink with mobile device 114, which is also an in-coverage device. Mobile device 115 on a vehicle, however, is an out-of-coverage device. In-coverage mobile device 114 establishes a sidelink with the out-of-coverage device 115.

In one novel aspect, the interruption procedure allows the UE to drop communication upon detecting one or more interruption events. In one scenario, UE 114 communicates with UE 115 through a V2X SL, with data frames 171 and 172, respectively. Initially both UE 114 and UE 115 are synchronized to gNB 101 with the same timing. As UE 115 moving outside the coverage of gNB 101, UE 115 changes its synchronization source to GNSS 102. If these two sync sources, such as GNSS 102 and gNB 101, are not synced, the SL communication between UE 114 and UE 115 will be ceased since UE 114 does not have any information about the change of synchronize source of UE 115. Thus, when UE communicates for a NR V2X sidelink unicast and groupcast services and changes its synchronization reference source to another source that is asynchronous to the previous one, the transmission UE shall cease the communication after detecting radio link failure. When a UE supports NR V2X sidelink only, the UE is allowed to drop NR V2X SL transmission or reception for up to one millisecond when synchronization source is changed.

In one novel aspect, the UE detects an interruption event and performs the interruption procedure based on the interruption event. FIG. 1 illustrates a top-level interruption event 180, which includes an SL synchronization source change event 181 and a SL switch event 182. In one embodiment 181, the interruption event is the change of the SL synchronization sources. Each V2X devices has a synchronization source. The synchronization signal can come from a satellite, such as the GNSS, a base station, or a synchronization reference UE, the syncRef UE. There are two scenarios that triggers the SL synchronization source change. The first scenario is that the two synchronization sources that UE switches between are not synchronized. The second is that the two synchronization sources that UE switches between are synchronized and they are from different types including GNSS and gNB/eNB; GNSS and SyncRef UE; gNB/eNB and SyncRef UE. When two synchronization sources that UE switches between are synchronized but from different type of sources, a unified interruption requirement is defined since there is no timing adjustment between the switching. However, when two synchronization sources that UE switches between are not synchronized, the UE behavior in the NR will be different from the LTE SL. In LTE, the design focused on broadcast services. A signal is broadcasted to all surrounding UEs. The UE needs to monitor all messages received. When the synchronization source that UE switches between are not synchronized, the UE will have a short interruption duration, such as one millisecond, and continue to broadcast the signals with the new timing. In NR SL, the new type of groupcast and unicast communication are introduced. Unlike the broadcast communication, the NR SL communication is dedicated to one UE with the groupcast or unicast link. In one novel aspect, upon detecting the interruption event, the UE performs interruption procedure for a preconfigured period allowing the transmission or the reception of the communication to be dropped during the predefined period.

FIG. 1 further illustrates simplified block diagrams of a base station and a mobile device/UE for interruption handling. gNB 101 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 101. Memory 151 stores program instructions and data 154 to control the operations of gNB 101. gNB 101 also includes a set of control modules 155 that carry out functional tasks to communicate with mobile stations.

UE 112 has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown). A first RF module is used for HF transmitting and receiving, and the other RF module is used for different frequency bands transmitting and receiving, which is different from the HF transceiver. RF transceiver 163 also converts received baseband signals from processor 162, converts them to RF signals, and sends out to antenna 165. Processor 162 processes the received baseband signals and invokes different functional modules to perform features in the UE 112. Memory 161 stores program instructions and data 164 to control the operations of the UE 112. Antenna 165 sends uplink transmission and receives downlink transmissions to/from antenna 156 of gNB 101.

The UE also includes a set of control modules that carry out functional tasks. These control modules can be implemented by circuits, software, firmware, or a combination of them. A sidelink module 191 establishes a first SL in the wireless network, wherein the first SL is configured with a first synchronization source. An interruption detection module 192 detects an interruption event, wherein the interruption event is one selecting from a synchronization source change of the first SL, and a switching between the first SL and a second SL of the UE, and wherein the first SL and the second SL are each a type of vehicle-to-everything (V2X) link selecting from a new radio (NR) V2X link and a long term evolution (LTE) V2X link, and wherein the first SL and the second SL is of different types. An interruption handler 193 performs an interruption procedure for a preconfigured period upon detecting the interruption event.

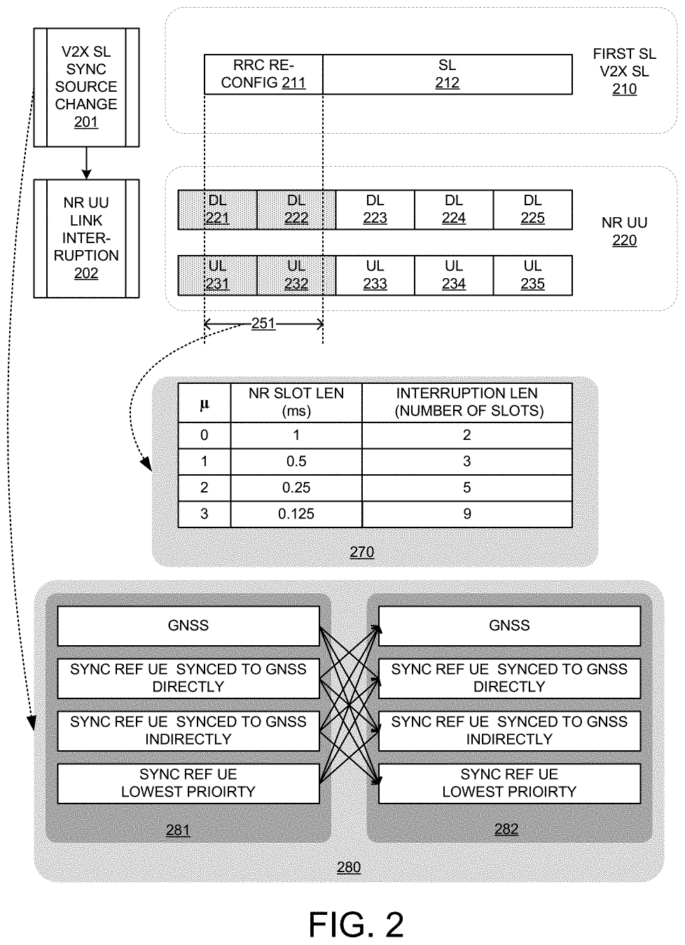

FIG. 2 illustrates exemplary diagrams of interruption handling for the WAN when the V2X sidelink changes synchronization source in accordance with embodiments of the current invention. In one embodiment, a UE capable of V2X sidelink communication may indicate its interest (initiation or termination) in V2X sidelink communication to the connected gNB. The UE establishes a first SL 210. At time 211, the UE performs RRC reconfiguration, which results in the synchronization source change. At time 212, the UE establishes the SL with the new synchronization source. First SL 210 can be a NR V2X sidelink or a LTE V2X sidelink. The UE also establishes a NR UU link 220 with exemplary DL slots 221, 222, 223, 224, and 225; and exemplary UL slots 231, 232, 233, 234, and 235. When the V2X SL performs RRC reconfiguration or synchronization source change, the UE performs interruption procedure for the NR UU link at DL 221 and 222, or UL 231 and 232. At step 201, the UE detects the V2X SL synchronization source change. At step 202, the UE performs the interruption procedure and allows the NR UU link 220 to stop transmission or reception for a preconfigured period 251.

In one embodiment, the preconfigured period is configured based on a slot configuration of the first SL, which changes the synchronization source. The UE is allowed an interruption of up to the duration shown in table 270 on the serving cell(s) during the RRC reconfiguration procedure that includes the V2X sidelink communication configuration setup and release. Table 270 illustrates an exemplary configuration for the interruption period. The number of slots allowing the transmission or reception to be stopped is based on the numerology configuration, in particular, the NR slot length. This interruption is for both uplink and downlink of the serving cell(s).

In one embodiment, when the UE supports only the first SL that is the NR V2X link, the UE is allowed to drop NR V2X SL transmission or reception for up to one millisecond when synchronization source is changed. Diagram 280 illustrates the possible scenarios for the synchronization source change from the initial synchronization source 281 to the changed synchronization source 282.

From GNSS
to syncRef UE that is synchronized to GNSS directly
to syncRef UE that is synchronized to GNSS in-directly
to syncRef UE that has the lowest priority

From syncRef UE that is synchronized to GNSS directly
to GNSS
to syncRef UE that is synchronized to GNSS in-directly
to syncRef UE that has the lowest priority

From syncRef UE that is synchronized to GNSS in-directly
to GNSS
to syncRef UE that is synchronized to GNSS directly
to syncRef UE that has the lowest priority

From syncRef UE that has the lowest priority
to GNSS
to syncRef UE that is synchronized to GNSS directly
to syncRef UE that is synchronized to GNSS in-directly

UE is allowed to interrupt any NR V2X sidelink signals. The interruption procedure allows the UE to interrupt any V2X link signals comprising physical side link shared channel (PSSCH), physical side link control channel (PSCCH), physical side link broadcast channel (PSBCH), physical side link feedback channel (PSFCH), and sidelink synchronization signals (SLSS). The interruption shall occur immediately after the reselection of V2X synchronization reference source. When a V2X sidelink UE supports both eNB and gNB, the interruption shall occur after UE Uu link receiving the handover command on the old physical downlink shared channel (PDSCH) and before UE sending the new physical random-access channel (PRACH) when UE synchronization source changes from gNB to eNB or eNB to gNB.

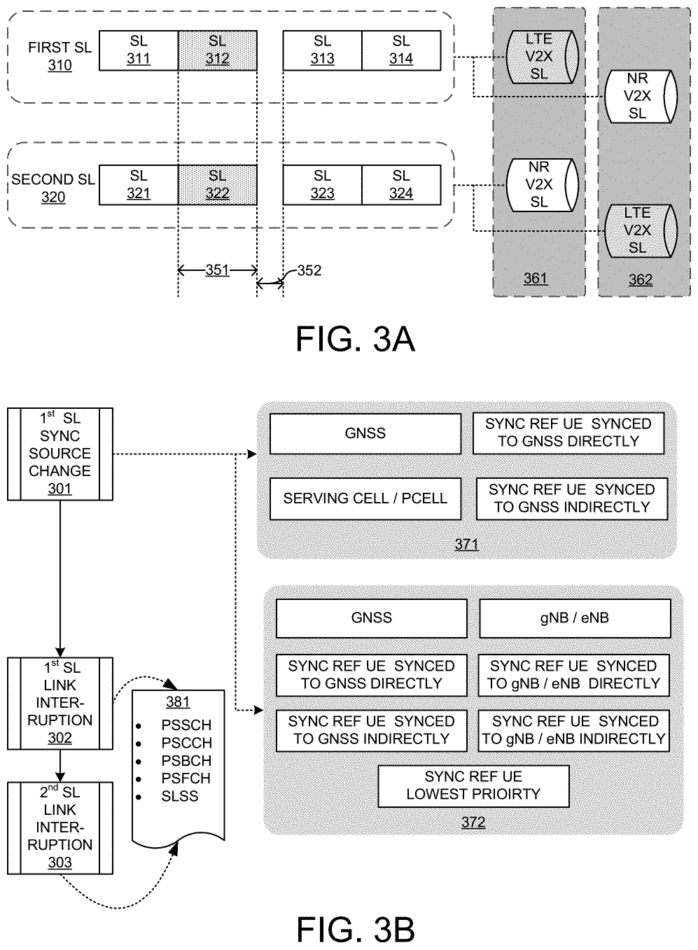

FIG. 3A illustrates exemplary diagrams of interruptions due to V2X sidelink synchronization source change in accordance with embodiments of the current invention. The UE establishes the first SL 310 and the second SL 320. The first SL and the second SL are each a type of V2X link selecting from a NR V2X link and a LTE V2X link, and wherein the first SL and the second SL is of different types. As illustrated, the UE supports both the NR V2X sidelink and LTE V2X sidelink. In one configuration 361, the first SL is a LTE V2X SL, and the second SL is a NR V2X SL. In another configuration 362, the first SL is a NR V2X SL, and the second SL is a LTE V2X SL. First SL 310 has exemplary SL transmission slots of 311, 312, 313, and 314. Second SL 320 has exemplary SL transmission slots of 321, 322, 323, and 324. The LTE SL and NR SL in the same ITS band will share a same timing. Thus, when one of SL link changes the synchronization source between two synchronization sources that are not synchronized, both SL communications shall be dropped to allow UE to adjust the timing. When the first SL changes the synchronization source, the UE performs the interruption procedure. In one embodiment, the interruption procedure allows the UE dropping transmission or reception of the first SL for up to 1 millisecond, and allows the UE dropping transmission or reception of the second SL for up to 1 millisecond. In one embodiment, the preconfigured interruption period 351 is configured. The timing offset 352 is configured to adjust the timing.

FIG. 3B illustrates exemplary diagrams of interruption handling for the V2X sidelink upon detecting the V2X sidelink synchronization source changes in accordance with embodiments of the current invention. The UE is configured with the first SL and the second SL. At step 301, the UE detects the synchronization source change of the first SL. At step 302, the UE performs the first SL interruption procedure. At step 303, the UE performs the second SL interruption procedure. In one embodiment 381, UE is allowed to interrupt any NR V2X sidelink signals including PSSCH, PSCCH, PSBCH, PSFCH and SLSS signals.

In the first scenario, the first SL is the LTE V2X sidelink. Diagram 371 includes the possible synchronization sources for the LTE V2X sidelink. When the UE supports both NR V2X sidelink and LTE V2X sidelink, the UE is allowed to drop NR V2X SL transmission or reception for up to 1 ms when LTE V2X sidelink synchronization source is changed:
From GNSS
   to Serving cell/PCell;
   to SyncRef UE that is synchronized to GNSS directly;
   to SyncRef UE that is synchronized to GNSS indirectly;
From SyncRef UE that is synchronized to GNSS directly
   to GNSS;
   to Serving cell/PCell;
   to SyncRef UE that is synchronized to GNSS indirectly;
From Serving cell/PCell
   to GNSS;
   to SyncRef UE that is synchronized to GNSS directly;
   to SyncRef UE that is synchronized to GNSS indirectly;
From SyncRef UE that is synchronized to GNSS indirectly
   to GNSS;
   to Serving cell/PCell;
   to SyncRef UE that is synchronized to GNSS directly.

UE is allowed to interrupt any NR V2X sidelink signals including PSSCH, PSCCH, PSBCH, PSFCH and SLSS signals. The interruption shall occur at the same time as LTE V2X sidelink synchronization source change. When UE communicates for a NR V2X sidelink unicast and groupcast services and changes its synchronization reference source to another source that is asynchronous to the previous one, the transmission UE shall cease the communication after detecting radio link failure.

In the second scenario, the first SL is the NR V2X sidelink. Diagram 372 includes the possible synchronization sources for the NR V2X sidelink. When a UE supports both NR V2X sidelink and LTE V2X sidelink, the UE is allowed to drop LTE V2X SL transmission or reception for up to 1 ms when NR V2X sidelink synchronization source is changed:
From GNSS
   to syncRef UE that is synchronized to GNSS directly
   to syncRef UE that is synchronized to GNSS in-directly
   to gNB/eNB
   to syncRef UE that is synchronized to gNB/eNB directly
   to syncRef UE that is synchronized to gNB/eNB in-directly
   to syncRef UE that has the lowest priority
From syncRef UE that is synchronized to GNSS directly
   to GNSS
   to syncRef UE that is synchronized to GNSS in-directly
   to gNB/eNB
   to syncRef UE that is synchronized to gNB/eNB directly
   to syncRef UE that is synchronized to gNB/eNB in-directly
   to syncRef UE that has the lowest priority
From syncRef UE that is synchronized to GNSS in-directly
   to GNSS
   to syncRef UE that is synchronized to GNSS directly
   to gNB/eNB
   to syncRef UE that is synchronized to gNB/eNB directly
   to syncRef UE that is synchronized to gNB/eNB in-directly
   to syncRef UE that has the lowest priority
From gNB/eNB
   to GNSS
   to syncRef UE that is synchronized to GNSS directly
   to syncRef UE that is synchronized to GNSS in-directly
   to syncRef UE that is synchronized to gNB/eNB directly
   to syncRef UE that is synchronized to gNB/eNB in-directly
   to syncRef UE that has the lowest priority
From syncRef UE that is synchronized to gNB/eNB directly
   to GNSS
   to syncRef UE that is synchronized to GNSS directly
   to syncRef UE that is synchronized to GNSS in-directly
   to gNB/eNB
   to syncRef UE that is synchronized to gNB/eNB in-directly
   to syncRef UE that has the lowest priority
From syncRef UE that is synchronized to gNB/eNB in-directly
   to GNSS
   to syncRef UE that is synchronized to GNSS directly
   to syncRef UE that is synchronized to GNSS in-directly
   to gNB/eNB
   to syncRef UE that is synchronized to gNB/eNB directly
   to syncRef UE that has the lowest priority
From syncRef UE that has the lowest priority
   to GNSS
   to syncRef UE that is synchronized to GNSS directly
   to syncRef UE that is synchronized to GNSS in-directly
   to gNB/eNB
   syncRef UE that is synchronized to gNB/eNB directly
   syncRef UE that is synchronized to gNB/eNB in-directly

In another embodiment, the interruption procedure is to prohibit the UE change synchronization source of the NR V2X link to a gNB.

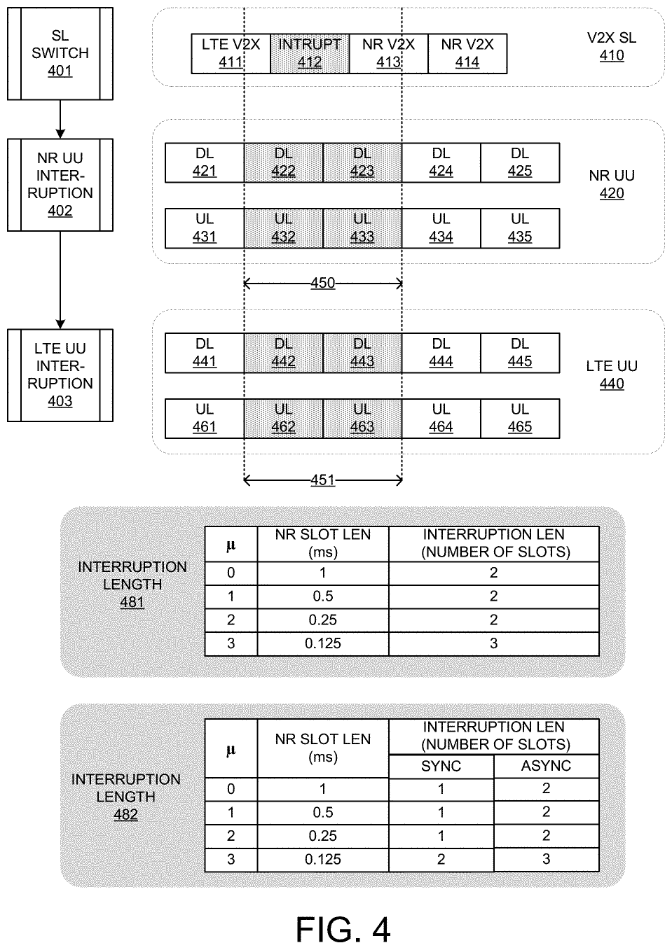

FIG. 4 illustrates exemplary diagrams of interruption detecting and handling due to the switching between the LTE V2X sidelink and the NR V2X sidelink in accordance with embodiments of the current invention. The UE establishes the first SL, the V2X SL 410. The UE also establishes a Uu link. The Uu link can be a NR Uu link 420 and/or LTE Uu link 440. The NR Uu link 420 has exemplary DL transmission slots of 421-425, and UL transmission slots of 431-435. The LTE Uu link 420 has exemplary DL transmission slots of 441-445, and UL transmission slots of 461-465. In one embodiment, the interruption event is the switching between the first SL and the second SL of the UE. At time 411, V2X SL 410 is the LTE V2X. At time 412, the UE switches V2X SL 410 to NR V2X and causes an interruption. At time 413 and 414, V2X SL 410 successfully operates with NR V2X. When the UE capable of switching between LTE V2X sidelink and NR V2X sidelink, the UE is allowed an interruption to the NR Uu link of up to the duration 450 and/or 451 on the serving cell(s) during the LTE V2X sidelink and NR V2X sidelink switch. At step 401, the UE detects the SL switch. In one embodiment, the SL switches from the LTE V2X to the NR V2X. In another embodiment, the SL switches from the NR V2X to the LTE V2X. The UE performs the interruption procedure upon detecting the SL switch event. The interruption procedure interrupts before a last LTE SL subframe and after a first NR SL slot when the first SL is the LTE V2X. The interruption procedure interrupts before a last NR SL slot and after a first LTE SL subframe when the first SL is the NR V2X.

In one embodiment, the preconfigured interruption period due to the SL switch is based on the slot configuration of the first SL as illustrated in table 481. The UE is allowed an interruption to the NR Uu link of up to the duration two subframes on the serving cell(s) during the LTE V2X sidelink and NR V2X sidelink switch. The interruption shall not occur before the last LTE SL subframe or NR SL slot switching from and after the first NR SL slot or LTE SL subframe switching to. The previous V2X sidelink communication will be ceased after the switching. This interruption is for both uplink and downlink of the serving cell(s).

In another embodiment, the preconfigured interruption period due to the SL switch is based on the slot configuration of the first SL and whether it is a synchronized switch or asynchronized switch as illustrated in table 482. When a UE capable of switching between LTE V2X sidelink and NR V2X sidelink, the UE is allowed an interruption to the NR Uu link of up to the duration shown in table 482 on the serving cell(s) during the LTE V2X sidelink and NR V2X sidelink switch. The UE is allowed an interruption to the NR Uu link of up to the duration two subframes on the serving cell(s) for asynchronized case and one subframe on the serving cell(s) for synchronized case during the LTE V2X sidelink and NR V2X sidelink switch.

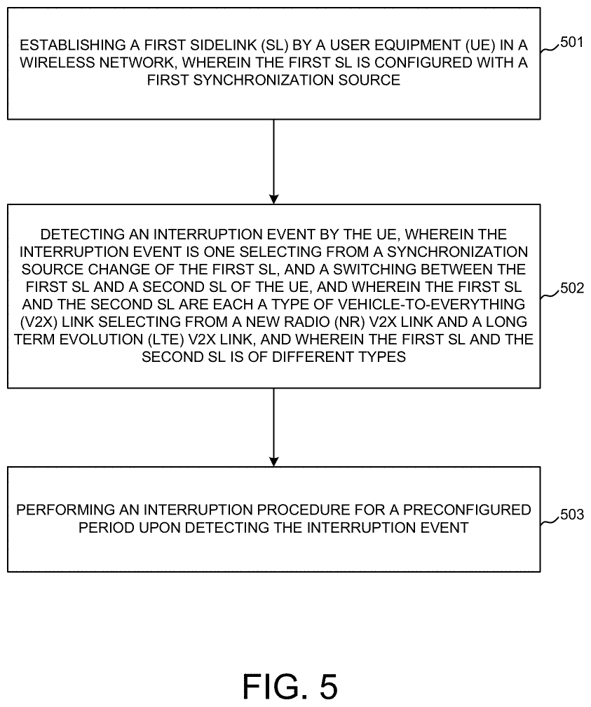

FIG. 5 illustrates an exemplary flow chart for the interruption handling for the V2X communication in accordance with embodiments of the current invention. At step 501, the UE establishes a first sidelink in a wireless network, wherein the first SL is configured with a first synchronization source. At step 502, the UE detects an interruption event, wherein the interruption event is one selecting from a synchronization source change of the first SL, and a switching between the first SL and a second SL of the UE, and wherein the first SL and the second SL are each a type of V2X link selecting from a NR V2X link and a LTE V2X link, and wherein the first SL and the second SL is of different types. At step 503, the UE performs an interruption procedure for a preconfigured period upon detecting the interruption event.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
establishing a first sidelink (SL) by a user equipment (UE) in a wireless network, wherein the first SL is configured with a first synchronization source;
detecting an interruption event by the UE, wherein the interruption event is one selecting from a synchronization source change of the first SL, and a switching between the first SL and a second SL of the UE, and wherein the first SL and the second SL are each a type of vehicle-to-everything (V2X) link selecting from a new radio (NR) V2X link and a long term evolution (LTE) V2X link, and wherein the first SL and the second SL is of different types; and
performing an interruption procedure for a preconfigured period upon detecting the interruption event.

2. The method of claim 1, wherein the interruption event is the synchronization source change of the first SL, and wherein the interruption procedure allows the UE dropping transmission or reception of the first SL for up to 1 millisecond.

3. The method of claim 2, wherein the interruption procedure is performed immediately after a reselection a synchronization source for the first SL.

4. The method of claim 3, wherein the UE establishes the second SL, and wherein the interruption procedure further comprises dropping transmission or reception of the second SL for up to 1 millisecond.

5. The method of claim 2, wherein the interruption procedure is to prohibit the UE change synchronization source of the first SL link to a gNB.

6. The method of claim 2, wherein the UE establishes a Uu link, and wherein the interruption procedure further interrupts the Uu link on one or more serving cells for the preconfigured period.

7. The method of claim 1, wherein the preconfigured period is configured based on a slot configuration of the first SL.

8. The method of claim 1, wherein the interruption event is the switching between the first SL and the second SL of the UE, and wherein the preconfigured period is configured based on a slot configuration of the first SL and whether the switch is a synchronized switch or an asynchronized switch.

9. The method of claim 1, wherein the interruption procedure interrupts before a last LTE SL subframe and after a first NR SL slot when the first SL is the LTE V2X, and wherein the interruption procedure interrupts before a last NR SL slot and after a first LTE SL subframe when the first SL is the NR V2X.

10. The method of claim 1, wherein the interruption procedure allows the UE to interrupt any V2X link signals comprising physical side link shared channel (PSSCH), physical side link control channel (PSCCH), physical side link broadcast channel (PSBCH), physical side link feedback channel (PSFCH), and sidelink synchronization signals (SLSS).

11. A user equipment (UE), comprising:
a sidelink (SL) module that establishes a first SL in the wireless network, wherein the first SL is configured with a first synchronization source;
an interruption detection module detects an interruption event, wherein the interruption event is one selecting from a synchronization source change of the first SL, and a switching between the first SL and a second SL of the UE, and wherein the first SL and the second SL are each a type of vehicle-to-everything (V2X) link selecting from a new radio (NR) V2X link and a long term evolution (LTE) V2X link, and wherein the first SL and the second SL is of different types; and
an interruption handler that performs an interruption procedure for a preconfigured period upon detecting the interruption event.

12. The UE of claim 11, wherein the interruption event is the synchronization source change of the first SL, and wherein the interruption procedure allows the UE dropping transmission or reception of the first SL for up to 1 millisecond.

13. The UE of claim 12, wherein the interruption procedure is performed immediately after a reselection a synchronization source for the first SL.

14. The UE of claim 13, wherein the UE establishes the second SL, and wherein the interruption procedure further comprises dropping transmission or reception of the second SL for up to 1 millisecond.

15. The UE of claim 12, wherein the interruption procedure is to prohibit the UE change synchronization source of the NR V2X link to a gNB.

16. The UE of claim 12, wherein the UE establishes a Uu link, and wherein the interruption procedure further interrupts the Uu link on one or more serving cells for the preconfigured period.

17. The UE of claim 11, wherein the preconfigured period is configured based on a slot configuration of the first SL.

18. The UE of claim 11, wherein the interruption event is the switching between the first SL and the second SL of the UE, and wherein the preconfigured period is configured based on a slot configuration of the first SL and whether the switch is a synchronized switch or an asynchronized switch.

19. The UE of claim 11, wherein the interruption procedure interrupts before a last LTE SL subframe and after a first NR SL slot when the first SL is the LTE V2X, and wherein the interruption procedure interrupts before a last NR SL slot and after a first LTE SL subframe when the first SL is the NR V2X.

20. The UE of claim 11, wherein the interruption procedure allows the UE to interrupt any V2X link signals comprising physical side link shared channel (PSSCH), physical side link control channel (PSCCH), physical side link broadcast channel (PSBCH), physical side link feedback channel (PSFCH), and sidelink synchronization signals (SLSS).
